(19) United States
(12) Patent Application Publication
(10) Pub. No.: US 2019/0385097 A1
(43) Pub. Date: Dec. 19, 2019

(54) SMART PARKING MANAGEMENT SYSTEM WITH DECAL ELECTRONICS SYSTEM

(71) Applicant: KING ABDULLAH UNIVERSITY OF SCIENCE AND TECHNOLOGY

(72) Inventors: Muhammad Mustafa HUSSAIN, Austin, TX (US); Irmandy WICAKSONO, Thuwal (SA)

(73) Assignees: KING ABDULLAH UNIVERSITY OF SCIENCE AND TECHNOLOGY, Thuwal (SA); KING ABDULLAH UNIVERSITY OF SCIENCE AND TECHNOLOGY, Thuwal (SA)

(21) Appl. No.: 16/074,194

(22) PCT Filed: Mar. 16, 2017
(86) PCT No.: PCT/IB2017/051547

§ 371 Date: Jul. 31, 2018

Related U.S. Application Data
(60) Provisional application No. 62/309,705, filed on Mar. 17, 2016.

(51) Int. Cl. G06Q 10/02; G08G 1/14

(52) U.S. Cl. CPC G06Q 10/02; G06K 19/0723; G08G 1/144; G08G 1/142

(57) ABSTRACT

Various examples are related to parking management, including identifying and reserving empty parking spaces. In one example, a smart parking space system includes a parking controller located at a parking space. The parking controller can identify a vehicle located at the parking space via an input sensor or a transceiver that initiates wireless communication with an electronic tag associated with the vehicle; and communicate a parking vacancy associated with the parking space to a remote computing device based at least in part on the identification of the vehicle. In another example, a computing device can receive parking vacancy data associated with a parking space from a parking controller; determine a parking vacancy associated with the parking space using the parking vacancy data; and encode for display on a client device a network page that includes an indication of the parking vacancy associated with the parking space.

### CROSS REFERENCE TO RELATED APPLICATIONS

This application claims priority to, and the benefit of, co-pending U.S. provisional application entitled “Smart Parking Management System with Decal Electronics System” having Ser. No. 62/309,705, filed Mar. 17, 2016, which is hereby incorporated by reference in its entirety.

### BACKGROUND

Often times, there are numerous vehicles traveling around a city during peak periods of a day. In most areas, there are different parking facilities available for vehicle parking throughout the city. Each parking facility may possess a different number of parking spaces. In addition, vehicles are entering and existing parking facilities in an unpredictable manner.

### SUMMARY

Aspects of the present disclosure are related to parking management. For example, parking management can be used for identifying and reserving empty parking spaces, as well as other applications.

In one aspect, among others, a smart parking space system comprises a parking controller located at a parking space, the parking controller configured to: identify a vehicle located at the parking space via an input sensor or a transceiver that initiates wireless communication with an electronic tag associated with the vehicle; and communicate a parking vacancy associated with the parking space to a remote computing device based at least in part on the identification of the vehicle. In one or more aspects, the parking controller and electronic tag can be decal electronic systems comprising a plurality of flexible electronic devices. The smart parking space system can further comprise an energy harvesting power source that supplies electrical energy to the smart parking space system. The energy harvesting power source can comprise at least one of an ambient vibration sensing device, a wind sensing device, a thermal sensing device, or a light sensing device.

In one or more aspects, a light source can be located at the parking space and electrically coupled to the parking controller, the light source indicating an availability of the parking space. The parking controller can configure the light source to indicate the availability of the parking space in response to a command from the remote computing device. The command can be provided in response to a parking request from a client device. The indicated availability of the parking space can comprise an indication that the parking space is vacant or reserved. In one or more aspects, the remote computing device can be communicatively coupled to a plurality of parking controllers, each of the plurality of parking controllers located in a corresponding parking space. The plurality of parking controllers can be communicatively coupled to the remote computing device via a wireless network. The smart parking space system can further comprising the remote computing device.

In another aspect, a non-transitory computer-readable medium embodying a program executable in at least one computing device. The program, when executed, can cause the at least one computing device to: receive, over a network, parking vacancy data associated with a parking space from a parking controller, the parking controller being located at the parking space; determine a parking vacancy associated with the parking space based at least in part on the parking vacancy data; and encode for display on a client device a network page that includes an indication of the parking vacancy associated with the parking space. In one or more aspects, the parking vacancy data can include parking space occupancy data, parking space reservation data, or parking space transaction data.

In one or more aspects, the program can further cause the at least one computing device to update an electronic parking record based at least in part on the parking vacancy data and the parking vacancy. The program can further cause the at least one computing device to: receive a reservation request associated with the parking space from the client device; and update the parking vacancy associated with the parking space in the electronic parking record to indicate a parking reservation. The program can cause the at least one computing device to, in response to a parking request from the client device, determine a vacant parking space based at least in on the electronic parking record. In one or more aspects, the program can further cause the at least one computing device to transmit the parking vacancy to the parking controller, wherein the parking controller facilitates changing a light source to a reservation state. The light source can be located at the parking space. The program can cause the at least one computing device to determine a location associated with the client device based at least in part on location system data received from the client device. In one or more aspects, determining a vacant parking space can be further based at least in part on the location associated with the client device.

In another aspect, a method comprises receiving, by at least one computing device, parking vacancy data associated with a parking space from a parking controller located at the parking space; determining a parking vacancy associated with the parking space based at least in part on the parking vacancy data; and generating for display on a client device a network page that includes an indication of the parking vacancy associated with the parking space. In one or more aspects, the parking vacancy data can include parking space occupancy data, parking space reservation data, or parking space transaction data. The indication can designate the parking space as vacant or reserved. The electronic parking record can be updated based at least in part on the parking vacancy data and/or the parking vacancy.

In one or more aspects, a reservation request associated with the parking space can be received from the client device; and the parking vacancy associated with the parking space in the electronic parking record can be updated to indicate a parking reservation. In response to a parking request from the client device, a vacant parking space can be identified based at least in on the electronic parking record. In one or more aspects, the parking vacancy can be transmitted to the parking controller, wherein the parking controller facilitates changing a light source to a reservation state. The light source can be located at the parking space. A location associated with the client device can be determined based at least in part on location system data received from the client device. In one or more aspects, the vacant parking space determination can be further based on the location associated with the client device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a networked environment, according to various embodiments of the present disclosure.

FIG. 2A is a block diagram illustrating an example of the parking controller in FIG. 1 using radio frequency identification (RFID) communication, according to various embodiments of the present disclosure.

FIG. 2B is a block diagram illustrating an example of the parking controller in FIG. 1 using wireless communication with a mobile device, according to various embodiments of the present disclosure.

FIG. 3A is a block diagram illustrating an example of the parking controller in FIG. 1 and FIG. 2A, according to various embodiments of the present disclosure.

FIG. 3B is a block diagram illustrating an example of the RFID tag in FIG. 1 and FIG. 2A, according to various embodiments of the present disclosure,

FIG. 4 is a flowchart illustrating an example of certain functionality implemented by portions of the parking management application executed in a computing environment in the networked environment of FIG. 1, according to various embodiments of the present disclosure.

FIG. 5 is a schematic block diagram that illustrates an example computing environment employed in the networked environment of FIG. 1, according to various embodiments.

The drawings illustrate only exemplary embodiments and are therefore not to be considered limiting of the scope of the embodiments described herein, as other equally effective embodiments are within the scope and spirit of this disclosure. The elements and features shown in the drawings are not necessarily drawn to scale, emphasis instead being placed upon clearly illustrating the principles of the exemplary embodiments. Additionally, certain dimensions or positionings may be exaggerated to help visually convey certain principles. In the drawings, similar references numerals between figures designates like or corresponding, but not necessarily identical, elements.

### DETAILED DESCRIPTION

Disclosed herein are various embodiments of methods and systems related to parking management, including identifying and reserving empty parking spaces. For example, when an individual is looking for an available parking space for their vehicle, the various embodiments of the present disclosure can be used to assist in identifying a location of an available parking space at respective parking facilities. The various embodiments of the present disclosure can identify whether a parking space is occupied by using wireless communication with a decal electronic system, an electronic tag, or a mobile device associated with the vehicle. In some cases, the electronic tag, the decal electronic system, or mobile device may be associated with an occupant of the vehicle. In these circumstances, the presence of the vehicle can be determined and further identification may be made for the vehicle occupant.

In addition, the various embodiments of the present disclosure can include a computing server that maintains a parking vacancy database that documents in real-time parking vacancies associated with individual parking spaces. In some situations, an individual may desire to reserve a parking spot for a particular period of time at a specific parking facility. The individual can render a parking management network site on a client device and transmit, using the client device, a parking reservation for a particular parking facility to the computing server. Further, the parking management network site can be used to provide services such as conducting parking transactions, determining anti-collision data, finding the nearest parking space, collecting real-time parking performance data, and providing parking performance data analysis.

A smart parking solution that identifies a vehicle via wireless communication with an electronic tag and/or a mobile device provides a reliable vehicle identification solution for a respective parking space. In some embodiments, among others, the decal electronic system, the electronic tag, or the mobile device can store data such as payment information and identification credentials. This enables the various embodiments of the present disclosure to conduct traditional parking services, such as parking transactions, in a faster manner. In addition, the various embodiments can provide new services such as tracking whether each individual parking spot at a parking facility is occupied in real-time. Thus, parking facilities can inform vehicle occupants of the number of available parking spaces and the location of available parking spaces within the parking facilities. This functionality enables vehicle occupants to quickly navigate to an available parking space, and in some cases, avoid certain parking facilities entirely because no parking is available. Accordingly, the various embodiments of the present disclosure can reduce traffic and save gas because vehicle occupants do not need to spend as much time identifying available parking. In some situations, global positioning system (GPS) location data, provided by the client device associated with the vehicle occupant, can assist the parking management site to identify the available parking options within a defined geographic area and identify which available parking facilities and parking spaces are closest to the current location of the client device. In some embodiments, the available parking space data can be used by an autonomous vehicle to navigate to a particular parking space.

In the following paragraphs, the embodiments are described in further detail by way of example with reference to the attached drawings. In the description, well known components, methods, and/or processing techniques are omitted or briefly described so as not to obscure the embodiments. Turning now to the drawings, a general description of exemplary embodiments of a smart parking system and its components are provided, followed by a discussion of the operation of the system.

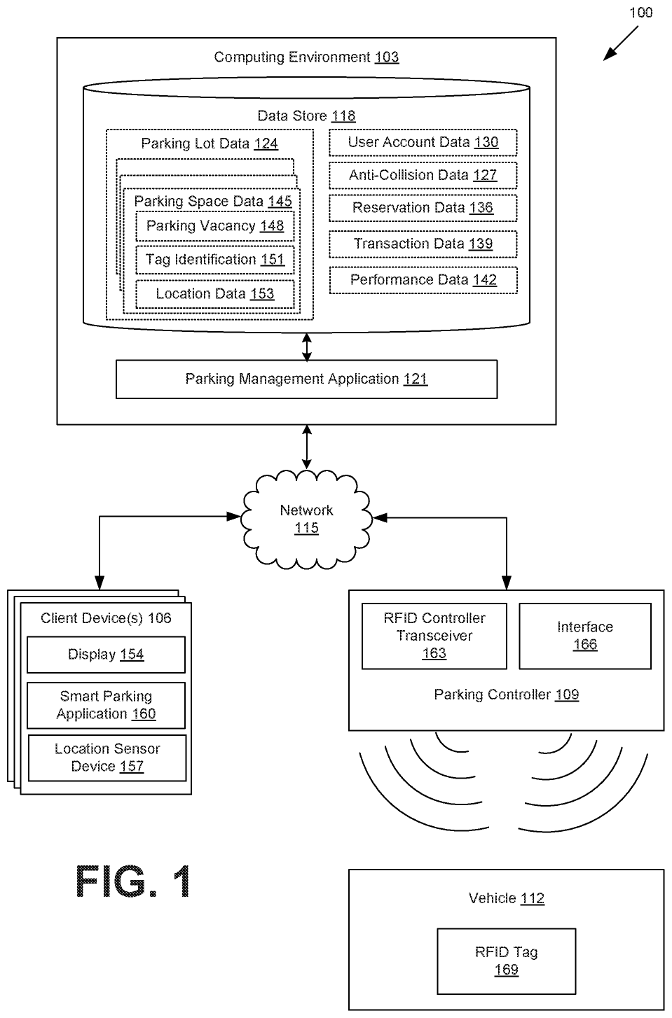

With reference to FIG. 1, shown is a networked environment 100 according to various example embodiments. The networked environment 100 includes a computing environment 103, a client device 106, a parking controller 109, a vehicle 112, which are in data communication via a network 115. The network 115 includes, for example, the Internet, intranets, extranets, wide area networks (WANs), local area networks (LANs), wired networks, wireless networks, or other suitable networks, etc., or any combination of two or more such networks.

The computing environment 103 may comprise, for example, a server computer or any other system providing computing capability. Alternatively, the computing environment 103 may employ a plurality of computing devices arranged, for example, in one or more server or computer banks or other arrangements. Such computing devices may be located in a single installation or distributed among different geographical locations. For example, the computing environment 103 may include a plurality of computing devices that together comprise a cloud computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data may be stored in a data store 118 that is accessible to the computing environment 103. In certain embodiments, the data store 118 may be representative of or comprise a plurality of data stores 118. The data stored in the data store 118, for example, may be associated with operation or execution of the various applications, components, and/or functional elements described below.

The components executed on the computing environment 103, for example, include a parking management application 121, and other applications, services, processes, systems, engines, or functionality not discussed in detail herein. The parking management application 121 can be executed to interact with a parking vacancy database that documents in real-time parking vacancies associated with individual parking spaces. In addition, the parking management application 121 can be used to provide services such as reserving parking spaces, conducting parking transactions, providing anti-collision data, finding the nearest parking space, collecting real-time parking performance data, and/or providing parking performance data analysis.

The data stored in the data store 118 includes, for example, parking lot data 124, anti-collision data 127, user account data 130, reservation data 136, transaction data 139, performance data 142, and potentially other data, Parking lot data 124 may comprise parking space data 145. The parking space data 145 may be associated with individual parking spaces in a parking facility. The parking space data 145 may comprise parking vacancy data 148, tag identification 151, and location data 153 associated with the particular parking space, such as a latitude, a longitude, and an elevation. The parking vacancy data 148 may correspond to whether the parking space is occupied, vacant, or reserved. The tag identification 151 may comprise data associated with the vehicle 112 or vehicle occupant occupying or reserving the parking space.

User account data 130 may comprise of data related to a plurality of users. For example, the user account data 130 may include a user profile associated with an individual user. The user profile may include a user name, a user address, vehicles associated with the user, and other user information. Reservation data 136 may comprise data associated with parking reservations. For example, reservation data 136 may include, for example, a reservation for a respective parking space on a particular day and time. The reservation may also include a period of time for which the parking space is reserved and the user associated with the reservation. Transaction data 139 may comprise a record of a parking transactions.

The client device 106 is representative of a plurality of client devices that may be coupled to the network 115, The client device 106 may comprise, for example, a processor-based system such as a computer system. Each computer system may be embodied in the form of a laptop computer, personal digital assistant, cellular telephone, smartphone, web pad, tablet computer system, game console, electronic book reader, or wearable activity tracker, for example, without limitation. The client device 106 may include a display 154 and a location sensor device 157. The display 154 may comprise, for example, one or more devices such as liquid crystal display (LCD) displays, gas plasma-based flat panel displays, organic light emitting diode (OLED) displays, LCD projectors, or other types of display devices, etc.

The client device 106 may be configured to execute various applications such as a smart parking application 160 and/or other applications. The smart parking application 160 may be executed in a client device 106, for example, to access network content served up by the computing environment 103 and/or other servers, thereby rendering a user interface on the display 154. The smart parking application 160 may, for example, correspond to a browser, a mobile application, etc., and the user interface may correspond to a network page, a mobile application screen, etc. The client device 106 may be configured to execute applications beyond the smart parking application 160 such as, for example, browsers, mobile applications, email applications, social networking applications, and/or other applications.

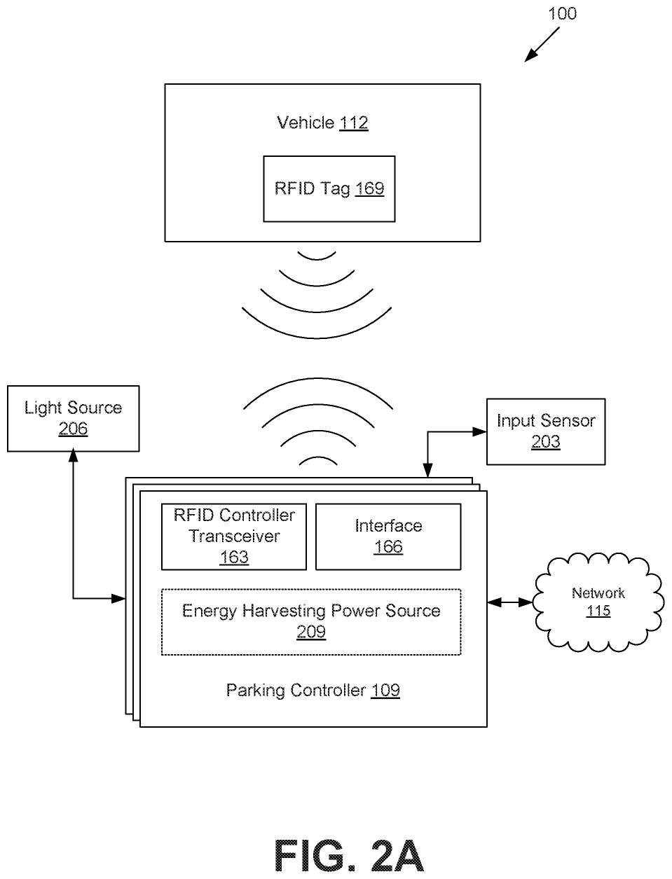

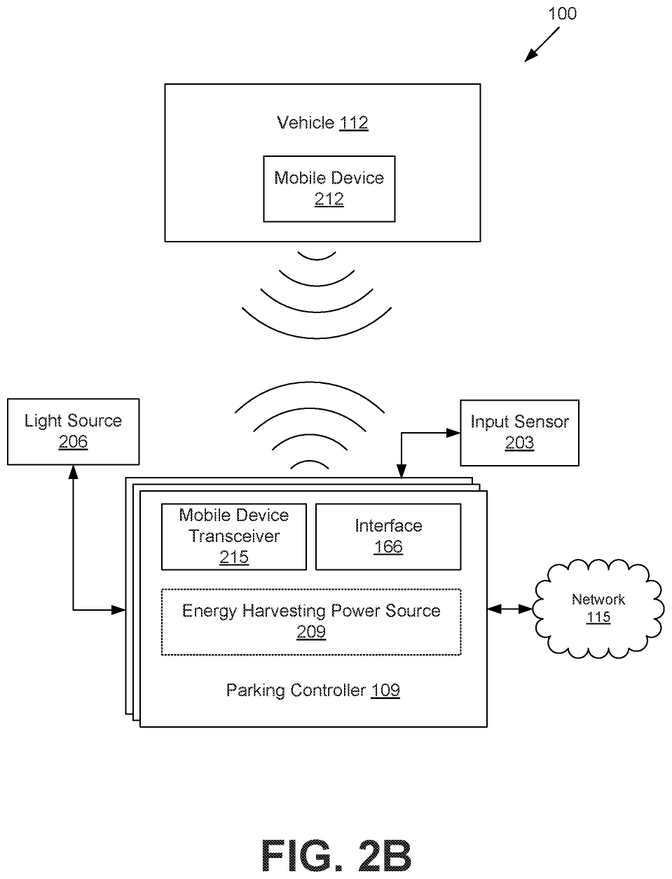

The parking controller 109 can be representative of a plurality of parking controllers that may be coupled to the network 115. The parking controller 109 may comprise an RFD controller transceiver 163 or input sensors 203 (FIGS. 2A and 2B) and an interface 166. Each parking controller 109 can be located at a parking space. In addition, the interface 166 can be used to access various peripheral components, such as sensors, storage devices, other transceivers, and other suitable components associated with the parking controller.

In some embodiments, among others, the parking controller 109 can be assembled with flexible electronic components and/or techniques. For example, the various components of the parking controller 109 (e.g., sensor(s), chips, energy harvesters, and/or battery) can be mounted on a thin, flexible substrate made of, e.g., a plastic, polymer or other suitable flexible substrate material. The components mounted on the flexible substrate can be sealed or enclosed for protection. The sealant or enclosure can be configured to allow the parking controller 109 to bend or deform. In addition, an enclosure of the flexible substrate and the associated components can also be manipulated to hold or maintain different shapes. For instance, the enclosure and the associated components can be configured in an arcuate shape. In this non-limiting example, among others, the flexible characteristics of the parking controller 109 allow it to be applied and conform to variations in a mounting surface. Thus, the parking controller 109, for instance, can be applied with or without an adhesive substance to a curved surface, such as a street curb, a parking block, a post, and other suitable locations.

Each vehicle 112 may be associated with an electronic tag, such as an RFID tag 169. In some embodiments, among others, the RFID tag 169 may be applied as an adhesive label to the vehicle 112. In other embodiments, among others, the RFID tag 169 may be included in a portable card that is carried with the individual. In another embodiment, among others, a decal electronic system may comprise the RFID tag 169. The decal electronic system can be configured as a flexible electronic system. In other words, because the various components of the decal electronic system can be mounted on a flexible plastic substrate made of, e.g., a plastic, polymer or other suitable flexible substrate material, the decal electronic system can be applied to and conform to the shape of the surface of an object. The decal electronic system can be secured to the surface using, e.g., with or without an adhesive substance. For example, the decal electronic system can be manipulated to be applied to various interior and/or exterior curved surfaces of the vehicle 112, such as a bumper, a side door, a windshield, an interior dashboard, and other suitable locations associated with the vehicle 112.

Next, a general description of the operation of the various components of the networked environment 100 is provided. To begin, as a vehicle stops at a parking space, the parking controller 109 located at the parking space uses an RFID controller transceiver 163 to identify that the vehicle is occupying the parking space. In particular, the RFID controller transceiver 163 initiates an RFID response from an RFID tag 169 associated with an occupant of the vehicle 112 or the vehicle 112 itself. In some embodiments, among others, the input sensor 203 (FIGS. 2A and 2B) may be used independently or in combination with the RFID controller transceiver 163 to determine that the parking space is occupied. The RFID tag 169 can be identified upon coming within a defined distance of the RFID controller transceiver 163. After a vehicle identification has been made, the parking controller 109 can communicate parking space data 145 to the computing environment 103. For example, the parking space data 145 can indicate in real-time that the parking space is occupied. In addition, the parking space data 145 may include the tag identification 151 and a time stamp indicating when the vehicle 112 arrived at the parking space. The parking management application 121 may receive the parking space data 145 and store it in the data store 118.

In addition, the parking management application 121 can be used to identify empty parking spaces by analyzing parking lot data 124 associated with a parking facility. For example, an occupant of the vehicle 112 may be near a particular parking facility and may desire assistance with finding a parking space. The vehicle occupant may use a client device 106 to identify available parking spaces using the smart parking application 160. The smart parking application 160 can cause the client device to transmit a request for available parking spaces. The request may specify a particular parking facility or a certain geographical area. In some embodiments, the smart parking application 160 can transmit location data associated with the present location of the client device 106 via the location sensor device 157. In response to receiving the request, the parking management application 121 can determine and transmit which parking spaces are presenting available or, in some cases, parking spaces that will become available at a later time.

Upon receiving the parking space data 145, the smart parking application 160 can be used to render on a user interface available parking spaces in the area. For each individual parking space, the user interface may include the location data 153 associated with a certain parking space, a parking rate, and whether the parking space can be reserved. In some cases, the current location of the client device 106 or vehicle 112 can also be indicated on the user interface. For example, a vehicle occupant can identify an available parking space on the user interface and navigate the vehicle to the location of the parking space. In some embodiments, the client device can provide the location data 153 of the parking space to an autonomous vehicle, and the autonomous vehicle can navigate to the parking space.

In another non-limiting example, the vehicle occupant may use the smart parking application 160 to reserve an available parking space. In this case, the smart parking application 160 transmits a reservation request for an identified parking space, Upon receipt of the reservation request, the parking management application 121 can then process the reservation request and store the appropriate data as reservation data 136.

In some embodiments, each parking controller 109 can used to collect data associated with vehicles parking at a respective parking space. For example, the parking controller 109 can store data associated with a length of time the vehicle 112 has been parked at the parking space.

With respect to FIG. 2A, the parking controller 109 can also be used to control a visual indicator that indicates the availability of a parking space, FIG. 2A shows an example of the parking controller 109 coupled to an input sensor 203 and a light source 206 located at the parking space. In particular, the input sensor 203 can be coupled to the interface 166 of the parking controller 109. The input sensor 203 may be, for example, a proximity sensor, a light sensor, a strain gauge sensor, a motion sensor, or other suitable sensors for detecting vehicles and vehicle characteristics. The parking controller 109 is also coupled to the light sourced 206. The light source 206 can be, for example, a light bulb, a light emitting diode (LED), or other suitable light sources.

In addition, FIG. 2A illustrates the parking controller 109 comprising an energy harvesting power source 209. The energy harvesting power source 209 may be, for example, a solar system, a piezoelectric system, a thermoelectric system, or other suitable energy harvesting device. Although FIG. 2A shows the energy harvesting power source 209 located within the parking controller 109, in some embodiments, the parking controller 109 may be coupled to an external energy harvesting power source. For example, the power controller 109 can be coupled to a solar system that is located at a top of the parking facility or some nearby structure.

In some embodiments, among others, an individual can use the client device 106 to transmit a request for a parking space reservation. After the parking management application 121 processes the request, the parking management application 121 can send a command to the corresponding parking controller 109 to configure the light source 206 to indicate that the corresponding parking space is reserved. For example, the parking controller 109 can configure the light source to turn on or to a particular color that indicates the parking space is reserved. In other embodiments, the parking controller 109 can facilitate the light source to turn to a particular color to indicate that the parking space is vacant. When the vehicle 112 approaches and/or arrives at the parking space, it can be identified by the parking controller 109 via the RFID tag 169. When the vehicle 112 is within a defined distance of the parking space, the parking controller 109 can provide an indication of reserved parking space via, e.g., the light source 206. For example, the light source 206 may begin flashing or changing color when the vehicle 112 approaches the reserved space. If the reserved space becomes occupied by an unauthorized vehicle, the parking controller 109 can provide an indication that can be sent to law enforcement for appropriate action.

In addition, the parking controller 109 can be self-powered via the energy harvesting power source 209. As such, the parking controller 109 can be located at the parking space or in a location nearby.

Turning to FIG. 2B, shown is a block diagram illustrating an example of the parking controller 109 in FIG. 1 identifying a mobile device 212 associated with the vehicle 112. In this embodiment, among others, the parking controller 109 can comprise a mobile device transceiver 215. Similar to FIG. 2A, the illustrated embodiments identify vehicles that are located at a respective parking space upon coming within a defined range of the mobile device transceiver 215.

In one or more aspects, the vehicle 112 can be identified based upon communications with the mobile device 212. The mobile device 212 can be a remote control configured to transmit tag identification 151 information associated with the individual and/or vehicle 112 to the parking controller 109 in response to a user input. The mobile device 212 can be a smartphone configured to transmit the tag identification 151 information associated with the individual and/or vehicle 112 to the parking controller 109 in response to a user input. In some embodiments, among other, the tag identification 151 information can be transmitted to the parking controller 109 via the network 115. In some embodiments, the mobile device 212 can comprise an application configured to automatically initiate transmission of the tag identification 151 information associated with the individual or the vehicle to the parking controller 109 in response to being within a range of the mobile device transceiver 215. In some embodiments, among others, the mobile device 212 can transmit the tag identification 151 information to the mobile device transceiver 215 via a wireless propriety protocol or a standard wireless protocol.

In one embodiment, among others, the mobile device 212 can provide location data 151 associated with the parking space to the vehicle 112. For example, the mobile device 212 may be a smartphone, and the smartphone may communicate the location data 151 to the vehicle 212 through a wired or wireless connection. The vehicle 112 can then provide driving instructions to the parking space for a driver, or in the case of an autonomous vehicle, the vehicle 112 can drive to the parking space.

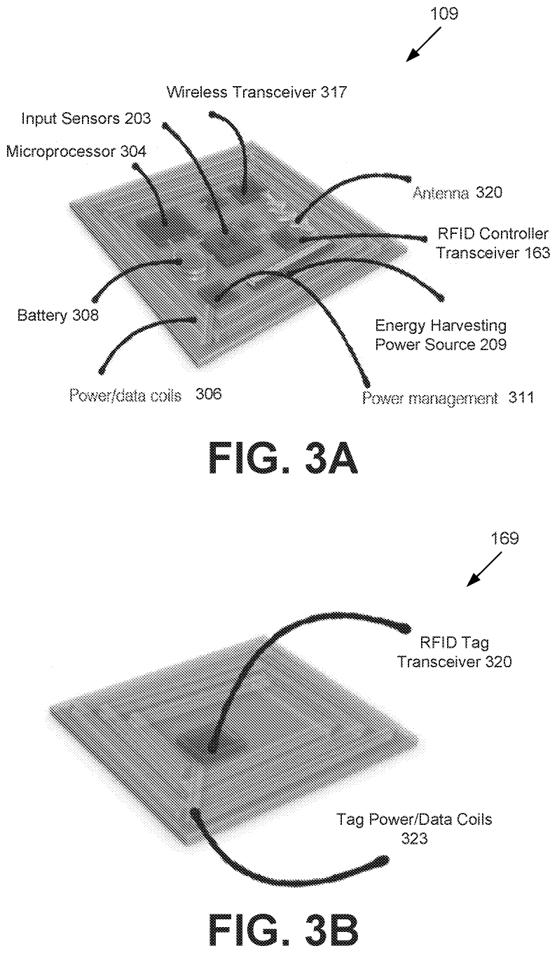

With reference to FIG. 3A, shown is a block diagram example of the parking controller 109 in FIG. 1 and FIG. 2A. As shown in FIG. 3A, the parking controller 109 may comprise, for example, a microprocessor 304 coupled to the input sensor 203, a RFID controller circuit, a wireless transceiver circuit, and a power circuit.

The RFID controller circuit may comprise, for example, the RFID controller transceiver 163, a power/data coil 306, and other suitable RFID components. When initiating an RFID communication with the RFID tag 169, the microprocessor 304 can communicate with the RFID controller transceiver 163. The RFID controller transceiver 163 can facilitate transmitting data embodied in a form of an energy signal to the RFID tag 169 via the power/data coils 306.

Next, the power circuit may comprise, for example, a battery 308, the energy harvesting power source 209, a power management circuit 311, and other suitable power components. The power management circuit 311 can be configured to distribute power from the energy harvesting power source 209 to different circuit portions of the parking controller 109. In some embodiments, among others, the energy harvesting power source 209 may receive a portion of power, and the power management circuit 311 may determine where to direct the power based on the various conditions associated with the parking controller 109. For example, the power management circuit 311 can configure the appropriate circuit to direct the power to the battery 308 in situations where the battery 308 is not fully charged. In other circumstances, the power can be directed to the RFID controller circuit.

In addition, the wireless transceiver circuit may include, for example, a wireless transceiver 317 coupled to an antenna 320. The wireless transceiver 317 can be a wi-fi transceiver, a cellular transceiver, or other suitable wireless transceivers. In some embodiments, the microprocessor 304 can use the wireless transceiver circuit to transmit and receive data to the computing environment 103 via the network 115.

In one embodiment, among others, the microprocessor 304, the input sensor 203, the RFID controller circuit, the wireless transceiver circuit, and the power circuit may be mounted on a flexible substrate. Additionally, these components and/or circuits can have flexible characteristics. The flexible characteristics of the components, the circuits, and the substrate enable the parking controller 109 to conform to any surface with or without an adhesive substance. Integration and miniaturization of the circuit and/or components can reduce the size of the parking controller 109, which can reduce the foot print of the parking controller 109. In addition, the flexible characteristics of these components, circuits, and the substrate can enable the parking controller 109 to be assembled such that they fit within in a thin, compact, and durable enclosure.

In addition, FIG. 3B illustrates a block diagram example of the RFID tag 169. As illustrated in FIG. 3B, the RFID tag 169 may comprise an RFID tag circuit that includes an RFID tag transceiver 320 and a tag power coil 323. The RFID tag circuit 169 may include circuit components associated with a passive, active, or battery-assisted passive RFID tag. In one embodiment, among others, the RFID tag circuit, the RFID tag transceiver 320 and a tag power coil 323 may be mounted on a thin, flexible substrate made of, e.g., a plastic, polymer or other suitable flexible substrate material. The components mounted on the flexible substrate can be sealed or enclosed for protection. The sealant or enclosure can be configured to allow the parking controller 109 to bend or deform. The flexible characteristics of the components, the circuits, and the substrate enable the RFID tag 169 to conform to the contour of a mounting surface with or without an adhesive substance. Integration and miniaturization of the circuit and/or components can reduce the size of the parking controller 109, which can reduce the foot print of the RFID tag 169 and allow it to fit within in a thin, compact, and durable enclosure.

In some embodiments, when the parking controller 109 initiates an RFID communication with a passive RFID tag, the RFID tag circuit receives the data embodied in the form of energy via the tag power/data coil 323. The received energy is used to supply power to the RFID tag circuit, namely the RFID tag transceiver 320. The supplied power is then used to process the transmitted data in the RFID tag transceiver 320 and initiate a reply transmission to the RFID controller transceiver 163 via the tag power/data coils 323.

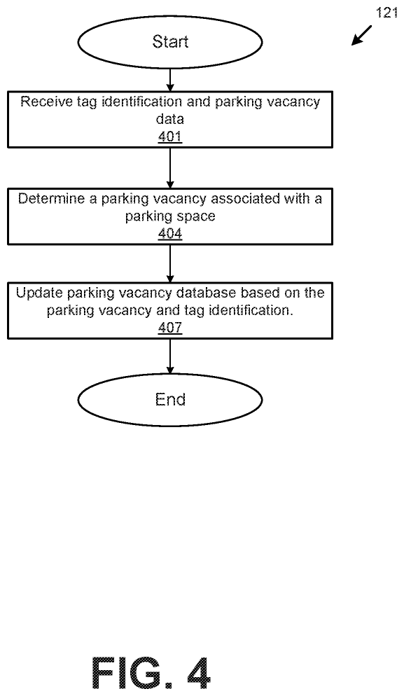

Referring next to FIG. 4, shown is a flowchart that provides one example of the operation of a portion of the parking management application 121 according to various embodiments. It is understood that the flowchart of FIG. 4 provides merely an example of the many different types of functional arrangements that may be employed to implement the operation of the portion of the parking management application 121 as described herein. As an alternative, the flowchart of FIG. 4 may be viewed as depicting an example of steps of a method implemented in the computing environment 103 (FIG. 1) according to one or more embodiments.

Beginning at 401, the parking management system 121 receives tag identification data 151, if any exists, and parking vacancy data 148 from one of the parking controllers 109. The parking controller 109 may transmit data to the computing environment 103 on a periodic basis, in response to a command, in response to an arrival of the vehicle, or at other suitable intervals. The tag identification 151 comprises data associated with vehicle 112 or a vehicle occupant. Next, at 404, the parking management application 121 determines a parking vacancy associated with the parking space based at least in part on the parking vacancy data 148. Subsequently, at 407, the parking management application 121 updates a parking vacancy database based on the parking vacancy data 148 and the tag identification data 151. The parking vacancy database provides a real-time electronic record of which parking spaces are vacant, occupied, reserved, or other suitable conditions associated with the parking space. Thereafter, the parking management application 121 ends as shown,

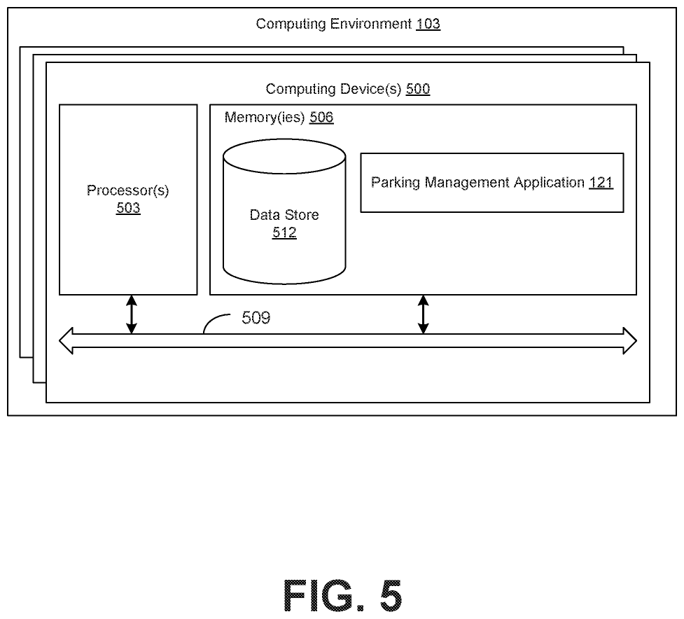

FIG. 5 illustrates a schematic block diagram of the computing environment 103 according to an example embodiment. The computing environment 103 includes one or more computing devices 500. Each computing device 500 includes at least one processor circuit, for example, having a processor 503 and a memory 506, both of which are coupled to a local interface 509. To this end, each computing device 500 may comprise, for example, at least one server computer or like device. The local interface 509 may comprise, for example, a data bus with an accompanying address/control bus or other bus structure as can be appreciated.

In various embodiments, the memory 506 stores data and software or executable-code components executable by the processor 503. For example, the 506 may store the parking management application 121, among other applications, as components for execution by the processor 503. The memory 506 may also store a data such as that stored in the data store 512 and other data.

It should be understood and appreciated that the memory 506 may store other executable-code components for execution by the processor 503. For example, an operating system may be stored in the memory 506 for execution by the processor 503. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

As discussed above, the memory 506 stores a number of software for execution by the processor 503. In this respect, the terms “executable” or “for execution” refer to software forms that can ultimately be run or executed by the processor 503, whether in source, object, machine, or other form. Examples of executable programs include, for example, a compiled program that can be translated into a machine code format and loaded into a random access portion of the memory 506 and executed by the processor 503, source code that can be expressed in an object code format and loaded into a random access portion of the memory 506 and executed by the processor 503, or source code that can be interpreted by another executable program to generate instructions in a random access portion of the memory 506 and executed by the processor 503, etc. An executable program may be stored in any portion or component of the memory 506 including, for example, a random access memory (RAM), read-only memory (ROM), magnetic or other hard disk drive, solid-state, semiconductor, or similar drive, USB flash drive, memory card, optical disc (e.g., compact disc (CD) or digital versatile disc (DVD)), floppy disk, magnetic tape, or other memory component.

In various embodiments, the memory 506 may include both volatile and nonvolatile memory and data storage components. Volatile components are those that do not retain data values upon loss of power. Nonvolatile components are those that retain data upon a loss of power. Thus, the memory 506 may comprise, for example, a random access memory (RAM), read-only memory (ROM), magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM may comprise, for example, a static random access memory (SRAM), dynamic random access memory (DRAM), or magnetic random access memory (MRAM), and/or other similar memory device. The ROM may comprise, for example, a programmable read-only memory (PROM), erasable programmable read-only memory (EPROM), electrically erasable programmable read-only memory (EEPROM), or other similar memory device.

Also, the processor 503 may represent multiple processors 503 and/or multiple processor cores and the memory 506 may represent multiple memories 506 that operate in parallel processing circuits, respectively or in combination. In such a case, the local interface 509 may be an appropriate network or bus that facilitates communication between any two of the multiple processors 503, between any processor 503 and any of the memories 506, or between any two of the memories 506, etc. The local interface 509 may comprise additional systems designed to coordinate this communication, including, for example, a load balancer that performs load balancing. The processor 503 may be of electrical or of some other available construction.

As discussed above, the parking management application 121 and the smart parking application 160 the may be embodied in software or executable-code components for execution by general purpose hardware as discussed above. Alternatively the same may be embodied in dedicated hardware or a combination of software, general, specific, and/or dedicated purpose hardware. If embodied in such hardware, each can be implemented as a circuit or state machine, for example, that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart or process diagram of FIG. 4 is representative of certain processes, functionality, and operations of embodiments discussed herein. Each block may represent one or a combination of steps or executions in a process. Alternatively or additionally, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as the processor 503. The machine code may be converted from the source code, etc. Further, each block may represent, or be connected with, a circuit or a number of interconnected circuits to implement a certain logical function or process step.

Although the flowchart or process diagram of FIG. 4 illustrates a specific order, it is understood that the order may differ from that which is depicted. For example, an order of execution of two or more blocks may be scrambled relative to the order shown. Also, two or more blocks shown in succession in FIG. 4 may be executed concurrently or with partial concurrence. Further, in some embodiments, one or more of the blocks shown in FIG. 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the parking management application 121, that comprises software or executable-code components can be embodied or stored in any tangible or non-transitory computer-readable medium or device for use by or in connection with an instruction execution system such as, for example, the processor 503. In this sense, the logic may comprise, for example, software or executable-code components that can be fetched from the computer-readable medium and executed by the instruction execution system. Thus, the instruction execution system may be directed by execution of the instructions to perform certain processes such as those illustrated in FIG. 4. In the context of the present disclosure, a “computer-readable medium” can be any medium that can contain, store, or maintain any logic, application, software, or executable-code component described herein for use by or in connection with an instruction execution system.

The computer-readable medium can comprise any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium may comprise a random access memory (RAM) including, for example, a static random access memory (SRAM), dynamic random access memory (DRAM), or magnetic random access memory (MRAM). In addition, the computer-readable medium may comprise a read-only memory (ROM), a programmable read-only memory (PROM), an erasable programmable read-only memory (EPROM), an electrically erasable programmable read-only memory (EEPROM), or other similar memory device.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Therefore, at least the following is claimed:

1. A smart parking space system, comprising:
a parking controller located at a parking space, the parking controller configured to:
identify a vehicle located at the parking space via an input sensor or a transceiver that initiates wireless communication with an electronic tag associated with the vehicle; and
communicate a parking vacancy associated with the parking space to a remote computing device based at least in part on the identification of the vehicle.

2. The smart parking space system of claim 1, wherein the parking controller and electronic tag are decal electronic systems comprising a plurality of flexible electronic devices.

3. The smart parking space system of claim 1, further comprising an energy harvesting power source that supplies electrical energy to the smart parking space system.

4. The smart parking space system of claim 3, wherein the energy harvesting power source comprises at least one of an ambient vibration sensing device, a wind sensing device, a thermal sensing device, or a light sensing device.

5. The smart parking space system of claim 1, wherein a light source is located at the parking space and electrically coupled to the parking controller, the light source indicating an availability of the parking space.

6. The smart parking space system of claim 5, wherein the parking controller configures the light source to indicate the availability of the parking space in response to a command from the remote computing device.

7. The smart parking space system of claim 6, wherein the command is provided in response to a parking request from a client device.

8. The smart parking space system of claim 6, wherein the indicated availability of the parking space comprises an indication that the parking space is vacant or reserved.

9. The smart parking space system of claim 1, wherein the remote computing device is communicatively coupled to a plurality of parking controllers, each of the plurality of parking controllers located in a corresponding parking space.

10. The smart parking space system of claim 9, wherein the plurality of parking controllers are communicatively coupled to the remote computing device via a wireless network.

11. The smart parking space system of claim 1, further comprising the remote computing device.

12. A non-transitory computer-readable medium embodying a program executable in at least one computing device, wherein the program, when executed, causes the at least one computing device to:
receive, over a network, parking vacancy data associated with a parking space from a parking controller, the parking controller being located at the parking space;
determine a parking vacancy associated with the parking space based at least in part on the parking vacancy data; and
encode for display on a client device a network page that includes an indication of the parking vacancy associated with the parking space.

13. The non-transitory computer-readable medium of claim 12, wherein the parking vacancy data includes parking space occupancy data, parking space reservation data, or parking space transaction data.

14. The non-transitory computer-readable medium of claim 12, the program further causes the at least one computing device to update an electronic parking record based at least in part on the parking vacancy data and the parking vacancy.

15. The non-transitory computer-readable medium of claim 14, wherein the program further causes the at least one computing device to:
receive a reservation request associated with the parking space from the client device; and
update the parking vacancy associated with the parking space in the electronic parking record to indicate a parking reservation.

16. The non-transitory computer-readable medium of claim 14, wherein the program, when executed, causes the at least one computing device to, in response to a parking request from the client device, determine a vacant parking space based at least in on the electronic parking record.

17. The non-transitory computer-readable medium of claim 12, wherein the program further cause the at least one computing device to transmit the parking vacancy to the parking controller, wherein the parking controller facilitates changing a light source to a reservation state.

18. The non-transitory computer-readable medium of claim 17, wherein the light source is located at the parking space.

19. The non-transitory computer-readable medium of claim 12, wherein the program, when executed, causes the at least one computing device to determine a location associated with the client device based at least in part on location system data received from the client device.

20. The non-transitory computer-readable medium of claim 19, wherein determining a vacant parking space is further based at least in part on the location associated with the client device.
